(19) United States
(12) Patent Application Publication
(10) Pub. No.: US 2006/0103923 A1
(43) Pub. Date: May 18, 2006

(54) Prism changing arrangement

(76) Inventors: Peter Dietrich, Oberkocken (DE); Peter Schnuell, Gleichen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/241,532

(22) Filed: Sep. 30, 2005

(30) Foreign Application Priority Data
Oct. 1, 2004 (DE) 10 2004 048 300.0

(51) Int. Cl. G02B 21/06

(52) U.S. Cl. 359/385; 359/831

(57) ABSTRACT

A prism changing device for a microscope for carrying out interference contrast examinations has a carrier for attaching the prism changing device to the microscope and a holder with at least two receptacles for prisms which is held at the carrier so as to be movable relative to it between at least two work positions in which one of the receptacles is arranged in the beam path of the microscope when the prism changing device is attached to the microscope. At least one of the receptacles is displaceable and rotatable relative to the holder in a plane transverse to the beam path of the microscope.

### CROSS-REFERENCE TO RELATED APPLICATION

This application claims priority of German Application No. 10 2004 048 300.0, filed Oct. 1, 2004, the complete disclosure of which is hereby incorporated by reference.

### BACKGROUND OF THE INVENTION

a) Field of the Invention

The present invention is directed to a prism changing device for microscopes.

b) Description of the Related Art

In a number of microscopy methods, particularly interference contrast studies under incident light, prisms are arranged in the beam path of the microscope. For example, in examinations with differential interference contrast (DIC), linearly polarized light is radiated through a suitably oriented Nomarski prism which, because of its birefringent properties, splits an incident illumination light bundle into two partial illumination light bundles which are inclined relative to one another and polarized orthogonal to one another and which are guided through an objective of the microscope so as to be offset relative to one another in the object plane to illuminate the object being analyzed. The objective generates an image of the object surface in infinity for each of the partial illumination light bundles. The corresponding partial imaging light bundles are guided again through the Nomarski prism and their offset is canceled. After filtering in an analyzer for linearly polarized light, in which components with the same polarization direction are generated, and focusing through a tube lens, the partial imaging light bundles can then interfere with each other in an intermediate image plane and path differences resulting, for example, from height differences of the object surface in direction of the offset of the partial illumination light bundles are converted to gray values. A good contrast of the occurring image is achieved when the offset of the partial illumination light bundles in the object plane lies approximately in the range of the resolution limit of the microscope objective that is used. Therefore, it is frequently necessary to select the beam splitting and, accordingly, the Nomarski prism, depending upon the microscope objective that is used. A change of contrast can be achieved by displacing the prism in a plane orthogonal to the beam path of the microscope.

However, height differences on the object surface are reflected in corresponding interference in the intermediate image only when they occur in the direction of the object plane in which the offset of the partial illumination light bundles is also present. In order to detect structures of the object surface in all directions, the object must be rotated, which is typically carried out by rotating a corresponding microscope stage. However, this is very involved and requires suitable microscope stages.

Often, an object is examined under different magnifications. Therefore, in DIC examinations, for example, different prisms must be used. The prisms can be arranged, for example, on a slide device so that when an objective is changed the corresponding slide with the prism must also be changed. This impedes a quick change of magnification in DIC examination.

Even when it is not necessary to change a prism when changing the objective, the position of the prism must generally be readjusted nevertheless in order to improve the contrast, which is very involved.

For this reason, a microscope with a prism changing device was proposed in U.S. Pat. No. 6,323,995 B1. Optical elements such as Nomarski prisms are held on a carrier of the prism changing device so as to be linearly displaceable by means of a guide. Alternatively, an optical element such as an analyzer can be rotatably supported on the carrier. The carrier can be rotated by means of a first motor into different locking positions in which one of the optical elements is arranged in the beam path of the microscope. The movable optical elements can be moved by means of a second motor so that adjustments of the optical elements can be carried out automatically when changing the optical elements in the beam path of the objective. Movement of the optical elements in one direction is carried out by a linear drive, movement in the opposite direction is carried out by a restoring member such as a spring. Therefore, it is necessary to move and possibly readjust the prism each time it is changed, for which purpose the second motor must be controlled in a corresponding manner.

JP 2001-091835 describes a microscope with a slide which is displaceable in a first direction and which carries a plurality of Nomarski prisms. The slide can be displaced by means of a first motor in such a way that one of the prisms is moved into the beam path of the microscope. The slide can be displaced in a direction orthogonal to the first direction by means of a second motor in order to adjust the prism arranged in the beam path of the microscope for DIC examination.

The two proposed solutions for changing a prism have the disadvantage that the microscope stage with the object must be rotated in order to examine an object with differential interference contrast.

In the article “C-DIC—a new microscopy method for efficient study of phase structures in incident light arrangement” by R. Danz and P. Gretscher, Photonik, pages 50 to 53, 2003, a modified examination method with differential interference contrast is proposed, wherein circularly polarized light is used instead of the linearly polarized light commonly used in conventional DIC examinations. By rotating the Nomarski prisms, which are also used in this method, contrasts can be generated in different directions of the object plane. However, a special slide is needed for each Nomarski prism that is used.

The article “Pulsed laser deposition and TIC microscopy—two methods for efficient and intelligent coating development” by S. Schey et al., Photonik, pages 42 to 45, 2004, describes a method for interference contrast examination of objects using circularly polarized light which is referred to in this case as TIC (total interference contrast) examination. In this method, as in examinations with circular differential contrast, a circularly polarized illumination light bundle is split by means of a birefringent polarizing prism into two partial illumination light bundles which serve to illuminate the object. The prism is constructed and arranged in such a way that an interference pattern can be observed which shows the height differences of the object surface or phase differences in the reflection at the surface of the object in a direction given by the splitting of the partial illumination light bundles. In this case also, it is possible to study the object in different directions in the object plane by rotating the prism.

Changing between prisms, which is necessary when changing the examination method or when changing an objective, requires changing the corresponding slide and, in particular, also a readjustment after changing, which is involved and time-consuming.

### OBJECT AND SUMMARY OF THE INVENTION

It is the primary object of the present invention to provide means which enable a simple examination of objects with interference contrast methods with a microscope that is constructed in a simple manner and in particular which enable rapid changing between different examination methods or examination conditions.

This object is met through a prism changing device for a microscope for carrying out interference contrast examinations having a carrier for attaching the prism changing device to the microscope and a holder with at least two receptacles for prisms which is held at the carrier so as to be movable relative to it between at least two work positions in which one of the receptacles is arranged in the beam path of the microscope when the prism changing device is attached to the microscope, wherein at least one of the receptacles is displaceable and rotatable relative to the holder in a plane transverse to the beam path of the microscope.

A microscope according to the invention has a prism changing device according to the invention and, further, an illumination device for generating circularly polarized light in incident illumination, a polarizer which has a quarter-wave plate and which is located in the illumination beam path, and an analyzer for circularly polarized light which is arranged in the imaging beam path downstream of the holder. In particular, the analyzer can be a quarter-wave plate with a polarization filter arranged downstream in the beam path for linearly polarized light.

Through the use of circularly polarized light in combination with rotatable prisms, the invention makes it possible to carry out interference contrast studies in any direction of the object plane without needing to rotate the object or a microscope stage carrying this object. Further, due to the fact that the prism is displaceable, preferably linearly, it is possible to adjust the contrast in any desired manner during the examination.

Further, by moving the holder relative to the carrier between the two work positions it is possible to change quickly between different prisms held in the receptacles, which substantially facilitates the examination of objects.

It is frequently desirable to examine the same object with different interference contrast methods or with different prisms using the same method but under modified conditions, for example, a different magnification. Therefore, it is preferable in the prism changing device according to the invention that the two receptacles are displaceable as well as rotatable relative to the holder in the plane transverse to the beam path of the microscope.

In order to adjust the contrast independent from the contrasting direction in which contrast detection is possible based on the orientation of the receptacle and, therefore, of the prism held therein, at least one of the movements of the receptacle relative to the holder, the rotation or the linear displacement, can preferably be carried out independent from the other.

For this purpose, in a preferred embodiment form of the prism changing device according to the invention, the receptacle which is rotatable relative to the holder is displaceably guided on an element that is rotatably mounted at the holder. This makes it possible to adjust the contrast in an optimal manner for a given contrasting direction in that the desired contrast is first adjusted by means of a linear displacement of the prism and the contrasting direction is then selected by rotating the receptacle.

When there is no need to readjust the contrast by means of linear displacement of the receptacle for every contrasting direction or rotational position of the receptacle and, therefore, of the prism held therein, it is possible to quickly examine structures of an object in different directions in the object plane. To this end, the rotatable receptacle is preferably rotatably supported on a carriage which is guided linearly at the holder in the prism changing device according to the invention. In this way, in an interference contrast examination with circularly polarized light, the contrast can first be adjusted by moving the carriage relative to the holder. The receptacle can then be rotated, and there is no displacement of the receptacle and, therefore, of the prism held therein. A quick overview of structures in all possible contrasting directions can be achieved in this way. In order to decouple the two possible movements and, accordingly, to enable a simple adjustment of position, the carriage is preferably guided linearly.

The receptacle which is movable relative to the holder is preferably moved by means of a drive device because the receptacle itself can be directly manipulated only with difficulty and, as a rule, not accurately enough by hand. The actuation of the drive device can be carried out in different ways.

In a embodiment form of the prism changing device according to the invention which is preferred because of its particularly simple construction, a drive device for moving the receptacle is designed for manual operation. To facilitate operation, a drive member of the drive device serving as an operator's control can be arranged in such a way that it can easily be reached from the side of the microscope when the prism changing device is arranged at a microscope.

In the prism changing device according to the invention, a drive device for moving the receptacles preferably comprises at least one actuator by means of which at least one of the receptacles can be displaced and/or rotated in order to achieve an accurately controlled or automatic adjustment of the position of the receptacle with respect to displacement and/or rotation. A stepping motor in particular can be used as an actuator for displacement. A linear motor or a piezoactuator, for example, can be used as an actuator for displacing the receptacle. Further, the actuator can be controlled manually by means of a control device, although this is preferably carried out automatically.

In principle, the actuator can be arranged on the holder of the prism changing device. Power can then be supplied by cable or preferably by sliding contacts, or also in a particularly preferred manner by contactless induction, wherein a power supply of an actuator for a receptacle need only be provided in the work position of the holder in which the corresponding receptacle is arranged in the beam path of the microscope.

However, in order to simplify the power supply in an embodiment form it is preferable that the actuator in the prism changing device can be coupled by a coupling to a drive member for moving the receptacle, wherein the drive member can be engaged with the coupling in at least one work position for moving the receptacle. The coupling can be disengaged again in order to move the receptacle out of its work position. The coupling is preferably designed in such a way that the actuator and the drive member for moving the receptacle are coupled only when the receptacle is located in its work position. Friction couplings, particularly friction wheel couplings, or contactless couplings, particularly magnetic couplings, are examples of couplings that may be used. The actuator can be rigidly connected to the microscope or preferably to the carrier. This embodiment form has the further advantage that a separate actuator need not be provided for each of the drive devices, although this is possible in principle.

When the positions of at least two receptacles can be adjusted, it is possible for the prism changing device to be constructed in a particularly simple manner mechanically in that a separate drive device is provided for each receptacle. This embodiment form is particularly advantageous in hand-operated drive devices. When using actuators, a coupling between the rotational movements of different receptacles can still be achieved in that the actuators are controlled in the same manner.

In order to avoid a separate adjustment of the rotational angles of the prisms when using at least two receptacles which are rotatable relative to the holder, a prism changing device according to the invention can preferably have a coupling device that couples rotational movements of the receptacles relative to the holder. The orientations of the receptacles relative to one another are selected in such a way that when the holder is changed into another work position the orientation of the receptacles relative to the carrier and, therefore, the corresponding orientation of prisms held in the receptacles remains constant. The coupling device can have, for example, toothed wheels which are connected, respectively, to the receptacles and a central toothed wheel in which all of the toothed wheels connected to the receptacles engage. By rotating the central toothed wheel or one of the receptacles, all of the receptacles can be rotated simultaneously by the same angle. Therefore, a rotation of the prisms is no longer necessary when changing prisms; instead, contrasts can be observed in the same direction also when changing a prism without a jumping of the image.

In order to change the direction in the object plane in which contrasts can be detected while retaining a fixed contrast, the drive device of the prism changing device according to the invention is preferably designed in such a way that the receptacles can be rotated and displaced relative to the holder independent from one another.

In principle, the drive device can have separate drive members for the rotational movement and for the displacement of a prism. For example, the drive device can comprise, as drive member, a hollow shaft and a shaft that is arranged within the hollow shaft and by means of which the receptacle is rotatable and displaceable, respectively, by a gear unit. In manual operation, there is the advantage that the corresponding drive members are arranged very close together and operation can accordingly be facilitated. However, drive members which are extensively independent from one another spatially can also be provided for rotation and displacement.

However, in order to make it possible to adjust the receptacles and the prisms which are held therein in a simple manner, in particular manually, it is preferable that the drive device or at least one of the drive devices has a drive member by means of which the rotatable and displaceable receptacle can be rotated and displaced.

In a preferred embodiment form of the prism changing device according to the invention, the drive member is a rotatable and displaceable shaft which is coupled to the receptacle for rotation thereof by means of a first gear unit for converting a linear movement of the shaft into a rotational movement of the receptacle and by means of a second gear unit for converting a rotational movement of the shaft into a linear movement of the receptacle. The gear units do not need to be connected directly to the receptacle; rather, it would be sufficient that a corresponding gear unit element engages at a carriage carrying the receptacle or at a rotatable element carrying the receptacle.

Alternatively, it is preferable that the drive member is a rotatable and displaceable shaft that is coupled to the receptacle for rotation thereof by means of a first gear unit for converting a rotational movement of the shaft into a rotational movement of the receptacle and by means of a second gear unit for converting a linear movement of the shaft into a linear movement of the receptacle.

By means of rotation and displacement of the same drive member, both of the embodiment forms described above make it possible to achieve a rotation and displacement of the receptacle which substantially facilitates manual adjustment in particular. At least one of the gear units that is used is preferably stepped down, which facilitates a very sensitive adjustment of the prisms.

In order to avoid readjusting the linear displacement and/or the rotational angle of at least one of the prisms held in the receptacles when changing back and forth between prisms, at least one blocking device is preferably provided in the prism changing device according to the invention for one of the receptacles or at least one drive device is provided, by means of which at least one of the receptacles is movable and in which the blocking device or the drive device, when not activated, blocks an automatic movement of the receptacle relative to the holder. For example, the bearing support of the receptacles or of a movable element of the drive device can fit so exactly and run so tightly that a movement of the receptacles relative to the holder is not carried out when the holder moves relative to the carrier in normal use, but the receptacle can easily be moved by means of the drive device. Appropriate braking members, guides, or bearings, for example, can be provided as a blocking device, and elements of the drive device, of a bearing of the receptacle at the holder, or also the receptacle itself, which elements are movable along or within these braking members, guides or bearings, can only be moved by forces which exceed the forces occurring during a normal change of work positions.

In principle, the holder can be held in any manner at the carrier so as to be movable relative to the latter. For example, the holder can be guided at the carrier so as to be displaceable. However, a particularly compact arrangement, especially in case the prism changing device is set up for receiving three or more prisms, is achieved when the holder is held at the carrier so as to be rotatable.

In the work positions, the respective prism must lie in the beam path of the microscope in a predetermined manner. For this purpose, the carrier can have a centering element or a centering device by means of which the carrier can be centered at an objective turret, a stand or a tube of a microscope in such a way that prisms which are held in the receptacles lie in the beam path of the microscope in a desired manner in the respective work positions.

The work positions of the holder can be fixed relative to the carrier in different ways. A prism changing device according to a preferred embodiment form of the invention has locking elements by means of which the holder can be locked in the work positions. For example, the holder can have corresponding recesses or grooves for this purpose, and a corresponding complementary locking element at the carrier or at the microscope to which the prism changing device is to be fastened engages in these recesses or grooves. For example, a spring-loaded roller that locks into the recesses or grooves when the holder occupies one of the work positions may be used as a complementary locking element. It is also possible to form the recesses at the carrier or at the microscope as complementary locking elements and to arrange a springing locking element at the holder.

In addition or alternatively, the prism changing device preferably has a motor for moving the holder relative to the carrier. The holder can be moved in a reproducible and accurate manner into the work positions by appropriately controlling the motor by means of a control device. When using a stepping motor, it can be determined that a work position has been reached when the stepping motor has carried out a corresponding predetermined quantity of steps. Alternatively, a suitable position transmitter which sends a predetermined signal when the holder has reached a given work position can also be used.

In order to be able to move a suitable prism into the beam path of the microscope automatically when changing objectives, the prism changing device according to the invention is preferably provided with a control device comprising a storage device for storing data about an allocation of prisms in the holder to determined objective types, an input interface for entering data about a type of objective that is currently in use, and a control output which is connected to the motor and by means of which the motor can be controlled to adjust one of the work positions corresponding to a type of objective entered by means of the input interface. In this case, the microscope according to the invention has, in addition to the prism changing device mentioned above, at least two objectives from a group of predetermined objective types and a detection device for detecting the type of objective found in the beam path, by means of which corresponding data about the currently used objective type can be supplied to the input interface of the prism changing device. To this end, the objectives can have a corresponding coding that can be read out by a suitable detection device when the objective is located in the beam path of the microscope. Alternatively, the objective type can also be determined by means of the position of an objective turret carrying the objectives.

Further, when the position of the prisms is changed by means of an actuator or a plurality of actuators, data about the position of a prism intended for a specific type of objective are preferably stored in the storage device and the control device has an additional control output connected to the actuator or actuators for adjusting the position of the receptacles.

Accordingly, when changing to another objective and prism, the adjustment of the prism in a given position relative to the holder can be carried out automatically.

The prism changing device according to the invention can have any number of prisms in principle. By prisms is meant, within the framework of the present invention, in particular assembled prismatic wedges. For examination using differential contrast methods, it is particularly preferable that a Nomarski prism is arranged in the rotatable receptacle. Nomarski prisms for use in differential interference contrast studies are known in principle. By means of a birefringent prism of this kind, a light bundle entering this prism in a given direction can be split into two differently polarized, angularly split partial light bundles which intersect outside the prism. In particular, the prisms can be constructed in such a way that an offset of the partial light bundles occurring in the object plane as a result of the angular splitting when the partial light bundles pass through a given microscope objective is on the order of magnitude of the resolution limit of the microscope objective. The direction in which the receptacle is displaceable corresponds to the direction in which the partial light bundles are offset relative to one another or extend at an inclination relative to one another.

Alternatively or in addition, a Wollaston prism is preferably arranged in the rotatable receptacle of the prism changing device according to the invention. A prism of this kind also splits a light bundle entering the prism in a given direction into two differently polarized, angularly split light bundles which, after passing through a given microscope objective in a direction parallel to the displacement direction of the receptacle, are offset in the object plane by a given distance preferably with a length of x=3.5 μm and y=3.5 μm for an objective with a 20× magnification. The angular splitting is preferably selected in such a way that the offset in the object plane is on the order of a multiple of the resolution limit of the objective that is used. A prism of this kind allows interference contrast examination with polarized light in which interference fringes occur in the microscope image of an object when the plane in which the incident light bundle is split does not lie in the exit pupil of the microscope objective. When using a microscope according to the invention with a prism changing device of the type mentioned above, the object can be examined by means of total interference contrast (TIC) which was mentioned in the beginning, wherein a rotation and displacement of the corresponding TIC prism is carried out instead of a rotation and displacement of the object.

In a particularly preferred manner, a prism changing device according to the invention has two Nomarski prisms and a TIC prism, all of which are held in rotatable and displaceable receptacles in such a way that it is possible to display an object alternatively in the form of a surface profile and an image in interference contrast simply by changing prisms without jumping or distortion of the image.

In order to carry out interference contrast examinations with different objectives with only one prism, a microscope according to the invention preferably has at least two objectives which are held at a turret and which can be moved into the beam path of the microscope and whose positions are identical to the exit pupils when they are arranged in the beam path of the microscope, and at least two of which objectives have a substantially identical product of the numerical aperture and focal length. In order to achieve a good contrast, the beam splitting on the object should correspond to the resolution limit of an objective. This condition is always met when the above-mentioned relationship between the numerical aperture and the focal length is met and when the ratio of the numerical aperture and magnification is substantially the same for each of the objectives.

In order to make it possible to examine an object with good contrast or high resolution, the prism changing device preferably has two prisms by means of which a light bundle entering the prisms in a given direction can be split into two differently polarized partial light bundles which are split angularly in a direction parallel to the displacement direction of the receptacle, wherein the angle between the partial light bundles generated by one prism is a predetermined multiple of the corresponding angle between the partial light bundles generated by the other prism. The prisms are preferably Nomarski prisms. When the splitting of the partial light bundles in the object plane which occurs after the partial light bundles pass through an objective is selected so as to be approximately equal to the resolution limit of the objective, a good contrast is achieved at full resolution corresponding to the objective aperture. For example, with sheared beam splitting in the object plane, a high contrast can be generated at reduced resolution. When objectives having the characteristics mentioned in the preceding paragraph are used, an examination with good contrast and full resolution on the one hand and an examination with high contrast and reduced resolution on the other hand can be carried out with only two Nomarski prisms for all objectives.

In order to be able to examine an object also in normal incident light or transmitted light, one of the receptacles of the prism changing device preferably contains no prisms or the holder has an opening which can be moved into the beam path of the microscope when the prism changing device is arranged at the microscope.

The invention is described more fully in the following with reference to the drawings.

### BRIEF DESCRIPTION OF THE DRAWINGS

In the drawings:

FIG. 1 shows a schematic partial view of a microscope with a prism changing device according to a first preferred embodiment form of the invention and a beam path using circular differential interference contrast for examination;

FIG. 2 is a schematic top view of the prism changing device in FIG. 1; and

FIG. 3 is a schematic top view of a prism changing device according to a second preferred embodiment form of the invention.

### DESCRIPTION OF THE PREFERRED EMBODIMENTS

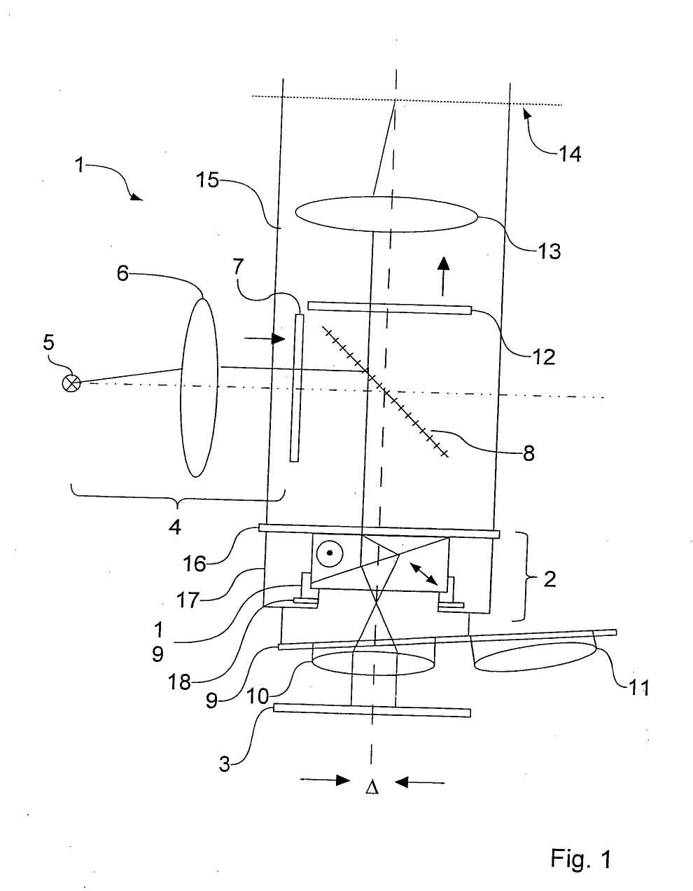

In FIG. 1, a microscope 1 with a prism changing device 2 according to a first preferred embodiment form of the invention for examining an object 3 has an illumination unit 4 which supplies a circularly polarized illumination light bundle and has a light source 5, illumination optics 6, only shown schematically, for imaging the light source 5 in infinity and a polarizer 7 which has a quarter-wave plate and is arranged downstream of the illumination optics, a semitransparent mirror 8 for deflecting the circularly polarized illumination light bundle to the prism changing device 2, and an objective turret 9 with three microscope objectives which is arranged in the illumination beam path following the prism changing device 2. Only objectives 10 and 11 are shown in FIG. 1. An illumination light bundle proceeding from the prism 19 is parallelized by the objective of the objective turret 9 arranged in the beam path of the microscope 1 and is reflected at the object. The reflected imaging light bundle passes through the prism changing device 2 and the semitransparent mirror 8 and is then focused by a tube lens 14 on an intermediate image plane 14 after passing through the analyzer 12 for circularly polarized light comprising a quarter-wave plate and an analyzer for linearly polarized light. The intermediate image plane 14 can be observed by an eyepiece, not shown in FIG. 1.

The objectives in the objective turret 9 which is held at a tube housing 15 of the microscope 1 have focal lengths that are stepped by a factor of 2 and magnifications of, e.g., 5, 10 and 20, and corresponding numerical apertures of 0.13, 0.25, and 0.5 so that the ratio of numerical aperture to magnification or the product of the focal lengths and the numerical apertures for the objectives is substantially constant. This gives focal length f=32.9 mm for objectives with a magnification of 5×, focal length f=16.5 mm for objectives with a magnification of 10×, and focal length f=8.2 mm for objectives with a magnification of 20×.

The objectives are constructed and arranged in such a way that their exit pupils occupy the same position when they are swiveled into the beam path of the microscope 1.

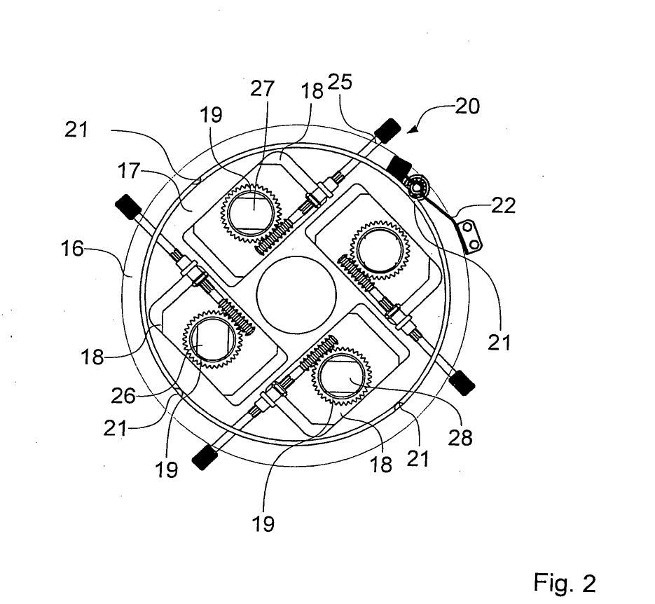

The prism changing device 2 is shown in greater detail in FIG. 2. It has a ring-shaped carrier 16, by means of which it is attached to the tube housing 15, and a holder 17 which is supported at the carrier 16 so as to be rotatable relative to the carrier 16 and which is in the form of a plate with four holes on which four identically constructed carriages 18 with receptacles 19 which are supported so as to be rotatable over the holes are held so as to be guided in a linearly displaceable manner in corresponding guides. A drive device 20 which is fastened to the holder 17 is used for the linear displacement and rotation of the receptacles 19.

The beam path of the microscope 1 extends through the opening of the carrier 16. A centering element, not shown in the drawings, at the carrier 16 serves to center the prism changing device 2 at the microscope 1. The centering element engages in a corresponding complementary centering element, not shown in the drawings, at the tube housing 15 and serves to orient the carrier 16 to the beam path of the microscope.

At four predetermined positions, the holder 17 has locking members in the form of grooves 21. A spring-loaded roller 22 which is held at the carrier 16 and which serves as a complementary locking member locks into the grooves 21 in order to stop the holder 17 in one of the four corresponding work positions associated with the locking members. The locking members 21 and the complementary locking member 22 are arranged, respectively, at the holder 17 and the carrier 16 in such a way that a corresponding receptacle 19 is arranged in the beam path of the microscope 1 when the carrier 16 is oriented by means of the centering element with the beam path of the microscope in each working position of the holder 17.

Each of the drive devices 20 for moving the receptacles 19 has a toothed wheel 23, which is constructed on the circumference of the respective receptacle 19, and an operator's control 25 which is mounted in a sleeve 24 by an external thread as a drive member in the form of a shaft. At its end contacting the toothed wheel 23, the operator's control 25 has a toothing which extends along the circumference and which engages in the toothed wheel 23 and thus, together with the latter, forms a first gear unit by means of which a linear movement of the drive member 25 is transformed into a rotational movement of the receptacle 19.

In order to transmit a rotational movement of the drive member 25, the sleeve 24 is connected to the drive member 25 by a spline shaft connection and has, along its circumference, an external thread, not shown in the drawings, which is supported in a corresponding internal thread (not shown) of the respective carriage 18. The spline shaft connection, together with the sleeve 24 and the internal thread in the respective carriage 18, forms a second gear unit for converting a rotational movement of the drive member 25 around its longitudinal axis into a displacing movement of the carriage 18 and, therefore, also of the receptacle 19.

The two gear units are designed in such a way that they prevent an automatic adjustment of the position of the respective receptacle 10 in azimuthal direction and in the movement direction of the carriage 18 during a rotating movement of the holder 17 relative to the carrier 16 from one work position into the next work position by means of only a very slight play of the movable elements.

Two Nomarski prisms 26 and 27 for examinations with circular differential interference contrast and a Wollaston prism 28 for examination with total interference contrast (TIC) are held in the receptacles 19. The fourth receptacle remains free to be swiveled into the work position so that the object 3 can be observed in normal incident light.

The Nomarski prisms 26 and 27 are conventional Wollaston prisms with Nomarski modifications in which the optical axis of an optically uniaxial birefringent crystal lies perpendicular to the optical axis of the microscope on the entrance side with reference to FIG. 1, while the optical axis of another birefringent crystal lies at an inclination to the optical axis of the microscope on the exit side. A circularly polarized illumination light bundle entering into one of these prisms is split in the prism into two partial illumination light bundles which are polarized orthogonal to one another and which diverge in the upper part of the prism (compare the beam path in FIG. 1) and run toward one another after refraction at the interface between the upper part of the Nomarski prism and the lower part of the Nomarski prism. The interference plane, by which is meant the plane in which the partial illumination light bundles resulting from the refraction at the interface between the upper part and lower part of the Nomarski prism intersect, lies outside the Nomarski prisms and in the exit pupil of the respective objective.

Through the use of circularly polarized light, the Nomarski prism can be rotated in any manner while examining the object, wherein the direction in which the partial illumination light bundles are offset relative to one another in the object plane after passing through the respective objective is rotated simultaneously. Therefore, by rotating the Nomarski prisms, differential interference contrasts can be observed in any direction of the object plane, i.e., orthogonal to the beam path of the objective.

The lateral beam splitting of the Nomarski prisms 26 and 27 differs by a factor of 2 in the example. Accordingly, there are many possibilities for observation in connection with the above-described objectives in the objective turret 9. Since each of the objectives has the same position of the exit pupil in relation to the tube housing 15, these objectives can be combined with an individual Nomarski prism 26, 27 in accordance with proper function regardless of their magnification v. The beam splitting of the Nomarski prism in the object plane and the contrast change according to the objective focal length f. Since the objectives with a fixed position of the exit pupils are stepped with respect to magnification v and aperture A by a factor of approximately 2, the ratio of the beam splitting D in the object plane given by
Δ=ε*f
(ε is the angular splitting of the Nomarski prism) to the resolution limit p of the objective with numerical aperture A
ρ=λ/2A
(λ=wavelength of the optical radiation that is used) does not change in the indicated series of objectives. Since the magnification of an objective is given by the ratio of the focal length of the tube lens to the focal length of the objective, the condition for a given contrast represented by the ratio of lateral beam splitting to the resolution limit of the objective is constant for the objectives mentioned above.

By changing between the Nomarski prisms 26 and 27, the object can be examined with good contrast (HR) at full resolution 1/ρ corresponding to the objective aperture A. With the second prism which generates sheared beam splitting in the object plane in the example, high contrast (HC) can be generated with all objectives at reduced resolution 1/ρ.

With objectives with a different position of the exit pupil and without constant stepping and magnification and aperture, a plurality of Nomarski prisms are needed instead of just two.

The Wollaston prism 28 is a conventional Wollaston prism which, together with the objectives in the object plane, generates a beam splitting which is a multiple of the resolution limit of the objectives that are used. A substantial characteristic of the Wollaston prism is that the interference plane, in this case the plane in which the illumination light bundle entering the Wollaston prism splits into two partial illumination light bundles, lies within the prism and therefore lies outside the objective pupil so that two double images occur which interfere with one another after passing through the analyzer 12 and produce an observable interference pattern. In this case also, an interference contrast examination is possible in any direction of the object plane by rotating the Wollaston prism 28 without having to rotate the object or a stage carrying this object.

For an examination with circular differential interference contrast, one of the Nomarski prisms 26 or 27 is moved into the beam path of the microscope 1 by rotating the holder 17 into a corresponding work position so that the plane spanned by the partial illumination light bundles corresponds to the direction in which the carriage 18 and, therefore, the receptacle 19 are linearly displaceable. The carriage 18 with the receptacle 19 and the Nomarski prism held therein is displaced linearly by the drive element or operator's control 25 in such a way that a desired contrast is achieved. The receptacle 19 with the Nomarski prism received therein is then rotated in a desired contrasting direction by means of the displacement the drive member 25.

The procedure for examination with total interference contrast (TIC) corresponds to that used for examination with circular differential interference contrast (this refers to prism rotation and prism displacement).

Once the displacements of the carriage 18 and the azimuthal orientations of the receptacles 19 have been carried out, the prisms can be exchanged in any manner without having to readjust the position of the prisms. In particular, it is easy to change between examinations with circular differential interference contrast and total interference contrast and back again. Further, the magnification can be changed in a simple manner by changing the objective without altering the adjustment.

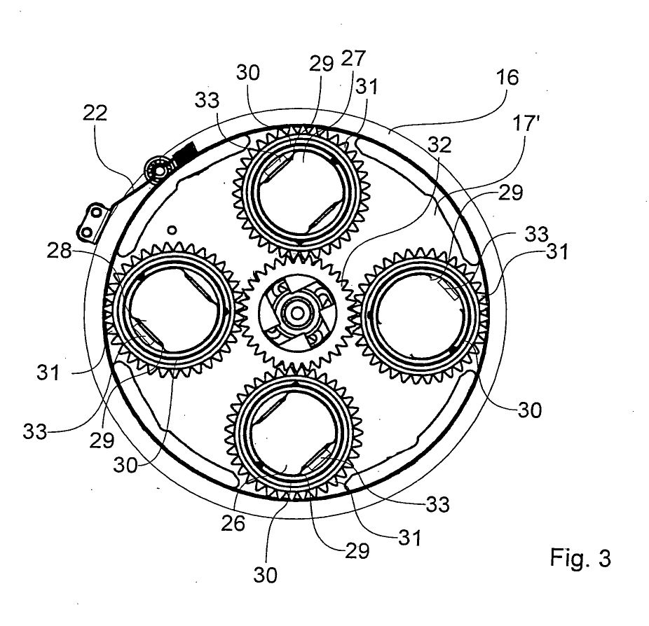

A prism changing device according to a second preferred embodiment form of the invention is shown schematically in FIG. 3. It differs from the prism changing device in the first embodiment example in the way that the receptacles are supported on the holder. Further, the receptacles are driven in a different way. The components that have not been changed have the same reference numbers as in the first embodiment example and the preceding remarks also apply.

Plates 30 which are rotatable relative to a holder 17′ are provided for each of the four receptacles 29 and the receptacles 29 which are constructed as carriages are guided on these plates 30 so as to be movable linearly. The holder 17′ differs from the holder 17 of the first embodiment example in that bearings are now provided for the plates 30 instead of the guides for the carriages 18. The arrangement of the holes in the holder 17′, the locking members 21 and the bearing support at the carrier 16 correspond to the first embodiment example.

The plates 30 have teeth 31 along their outer circumference which engage in the manner of a sun wheel in a central toothed wheel 32 supported on the holder 17′ so that this central toothed wheel 32 acts as a coupling element by which the rotation of the plate 30 and, therefore, of the receptacles 29 can be carried out in a rigidly coupled manner and therefore synchronously.

The drive device for the movement of the receptacles 29 has a drive member, not shown in the drawings, for rotating the receptacles 29, e.g., a knurled ring which is coupled with the central toothed wheel 32. Linear drives 33 are provided as actuators for the linear displacement of the carriages and receptacles 29 on the plates 30. The linear drives 33 are supplied with power and controlled by a control device, respectively, by sliding contacts, not shown in the drawings, between the carrier 16 and holder 17′ and sliding contacts between the holder 17′ and the plates 30.

The bearings of the central toothed wheel 32 on the holder 30 and the linear drives are constructed in such a way that an automatic adjustment of the position of the receptacles 29 relative to the holder 17 is prevented by friction in the bearing or between the movable parts of the linear drives when changing the work position of the holder 17.

This embodiment form makes is possible to change quickly between the different prisms. The direction in which contrasts can be observed is maintained constant automatically. Further, a contrast adjustment carried out at the start of the examination remains constant through the displacement of the prisms and receptacles 19 relative to the plates 30 so that there is no longer a need for readjustment.

A prism changing device according to a third preferred embodiment form of the invention differs from the prism changing device of the first embodiment example in that the corresponding drive members can be actuated by a motor held at the carrier 16 by means of a friction wheel coupling for displacement of the carriage 18 relative to the holder 17 when these drive members are in the work position.

A prism changing device according to a fourth preferred embodiment form of the invention differs from the second embodiment example in that, for one, a stepping motor moves the holder 17′ relative to the carrier 16. A control device is used to control the stepping motor. This control device has a storage device for storing data about the assignment of prisms in the holder to the types of objective, an input interface for entering data about the currently used type of objective, and a control output which is connected to the stepping motor and by means of which the stepping motor can be controlled for adjusting one of the work positions corresponding to an objective type that is entered by means of the input interface. Corresponding data about the currently used object type are obtained by determining the position of the objective turret by means of the position of the motor.

Further, the control device controls the linear drives depending on displacement data which are entered by a user by means of a user interface and which are stored in the control device.

While the foregoing description and drawings represent the present invention, it will be obvious to those skilled in the art that various changes may be made therein without departing from the true spirit and scope of the present invention.

### RERENCE NUMBERS

1 microscope

2 prism changing device

3 object

4 illumination unit

5 light source

6 illumination optics

7 polarizer

8 mirror

9 objective turret

10, 11 objective

12 analyzer

13 tube lens

14 intermediate image plane

15 tube housing

16 carrier

17, 17′ holder

18 carriage

19 receptacles

20 drive device

21 grooves

22 roller

23 toothed wheel

24 sleeve

25 operator's control

26, 27 Nomarski prism

28 Wollaston prism

29 receptacles

30 plate

31 teeth

32 toothed wheel

33 linear drives

What is claimed is:

1-24. (canceled)

25. A prism changing device for a microscope for carrying out interference contrast examinations, comprising:
a carrier for attaching the prism changing device to the microscope;
a holder with at least two receptacles for prisms which is held at said carrier so as to be movable relative to it between at least two work positions in which one of the receptacles is arranged in a beam path of the microscope when the prism changing device is attached to the microscope; and
wherein at least one of the receptacles being displaceable and rotatable relative to the holder in a plane transverse to the beam path of the microscope.

26. The prism changing device according to claim 25, wherein the two receptacles are linearly displaceable as well as rotatable relative to the holders in a plane transverse to the beam path of the microscope.

27. The prism changing device according to claim 25, wherein the rotatable receptacle is displaceably guided on an element that is mounted at the holder so as to be rotatable.

28. The prism changing device according to claim 25, wherein the rotatable receptacle is rotatably mounted on a carriage that is guided at the holder.

29. The prism changing device according to claim 25, wherein a drive device for moving the receptacle is designed for manual operation.

30. The prism changing device according to claim 25, wherein a drive device for moving the receptacles comprises at least one actuator which at least one of the receptacles can be displaced and/or rotated.

31. The prism changing device according to claim 30, wherein the actuator can be coupled by a coupling with a drive member for moving the receptacle, wherein the drive member for the movement of the receptacle can be engaged with the coupling in at least one work position.

32. The prism changing device according to claim 26, wherein a separate drive device is provided for each receptacle.

33. The prism changing device according to claim 26, wherein the rotatable receptacle is displaceably guided on the element that is mounted at the holder so as to be rotatable and wherein a separate drive device is provided for each receptacle.

34. The prism changing device according to claim 26, wherein a coupling device couples rotating movements of the receptacles relative to the holder.

35. The prism changing device according to claim 26, wherein the rotatable receptacle is displaceably guided on an element that is mounted at the holder so as to be rotatable and wherein a coupling device couples rotating movements of the receptacles relative to the holder.

36. The prism changing device according to claim 29, wherein the drive device is designed in such a way that a rotation and a displacement of the receptacle relative to the holder can be carried out independently from one another.

37. The prism changing device according to claim 29, wherein the drive device or at least one of the drive devices has a drive member by which the rotatable and displaceable receptacle can be rotated and displaced.

38. The prism changing device according to claim 37, wherein the drive member is a rotatable and displaceable shaft which is coupled with the receptacle for rotation thereof by a first gear unit for converting a linear movement of the shaft into a rotational movement of the receptacle and by a second gear unit for converting a rotational movement of the shaft into a linear movement of the receptacle.

39. The prism changing device according to claim 37, wherein the drive member is a rotatable and displaceable shaft that is coupled with the receptacle for rotation thereof by a first gear unit for converting a rotational movement of the shaft into a rotational movement of the receptacle and by a second gear unit for converting a linear movement of the shaft into a linear movement of the receptacle.

40. The prism changing device according to claim 25, wherein at least one blocking device is provided for a receptacle or at least one drive device is provided, by means of which at least one of the receptacles is movable and wherein the blocking device or the drive device, when not activated, blocks an automatic movement of the receptacle relative to the holder.

41. The prism changing device according to claim 25, wherein the holder is held at the carrier so as to be rotatable.

42. The prism changing device according to claim 25, having locking elements by which the holder can be locked in the work positions.

43. The prism changing device according to claim 25, having a motor for moving the holder relative to the carrier.

44. The prism changing device according to claim 43, wherein a control device is provided, which control device has a storage device for storing data about an allocation of prisms in the holder to determined objective types, an input interface for entering data about a type of objective that is currently in use, and a control output which is connected to the motor and by means of which the motor can be controlled to adjust one of the work positions corresponding to a type of objective entered by means of the input interface.

45. The prism changing device according to claim 25, wherein a Nomarski prism is arranged in the rotatable receptacle.

46. The prism changing device according to claim 25, wherein a Wollaston prism is arranged in the rotatable receptacle.

47. The prism changing device according to claim 25, wherein two prisms are provided by which a light bundle entering the prisms in a given direction can be split into two differently polarized partial light bundles which are split in a direction parallel to the displacement direction of the receptacle, wherein the angle between the partial light bundles generated by one prism is a predetermined multiple of the corresponding angle between the partial light bundles generated by the other prism.

48. The prism changing device according to claim 25, wherein one of the receptacles contains no prisms or the holder has an opening which can be moved into the beam path of the microscope when the prism changing device is held at the microscope.

49. A microscope with a prism changing device according to claim 25 and, further, with an illumination device for generating circularly polarized light in incident illumination and an analyzer for circularly polarized light which is arranged in the beam path downstream of the holder.

50. The microscope according to claim 49 with a prism changing device having a Wollaston prism arranged in the rotatable receptacle and wherein the microscope has at least two objectives which are held at a turret and which can be moved into the beam path of the microscope and whose positions are identical to the exit pupils when they are arranged in the beam path of the microscope, and at least two of which objectives have a substantially identical product of the numerical aperture and focal length.
